(19) United States
(12) Patent Application Publication
(10) Pub. No.: US 2008/0123006 A1
(43) Pub. Date: May 29, 2008

(54) Liquid crystal display panel and driving method thereof

(75) Inventors: Yi-Chun Wu, Hualien (TW); Wen-Jui Liao, Taichung (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 11/984,700

(22) Filed: Nov. 21, 2007

(30) Foreign Application Priority Data
Nov. 27, 2006 (TW) 95143850

(51) Int. Cl. G02F 1/133; G02F 1/1368; G02F 1/1343

(52) U.S. Cl. 349/42; 349/33

(57) ABSTRACT

A liquid crystal display (LCD) panel including a first substrate, a second substrate and a liquid crystal layer is provided. The first substrate includes a signal line, an insulating layer and a pixel electrode. The insulating layer is disposed between the signal line and the pixel electrode. The pixel electrode partly overlaps the signal line. The second substrate is parallel to the first substrate. The liquid crystal layer is disposed between the first substrate and the second substrate. When a cross-voltage is applied to the signal line and the pixel electrode, a fringe vertical field having different directions is formed on the peripheral of the partly overlapped area between the signal line and the pixel electrode, such that the liquid crystal layer produces at least one transition nucleus area according to the fringe vertical field.

This application claims the benefit of Taiwan application Serial No. 95143850, filed Nov. 27, 2006, the subject matter of which is incorporated herein by reference.

### BACKGROUND OF THE INVENTION

1. Field of the Invention

The invention relates in general to a liquid crystal display (LCD) panel and a driving method thereof, and more particularly to an LCD panel used in an optical compensated bend (OCB) LCD and a driving method thereof.

2. Description of the Related Art

Liquid crystal display (LCD) panel, having the features of lightweight, low power consumption and low radiation, has been widely used in various electronic products such as personal digital assistant (PDA), notebook, digital camera, digital video recorder (DVR), and mobile phone. Further due to the manufacturers' dedication in the research and development as well as facilities for large-scaled production, the quality of the LCD keeps improving and the applications of the LCD panel expand rapidly.

Optical compensated bend (OCB) LCD has an LCD panel including a top substrate, a bottom substrate and a liquid crystal layer. The top substrate includes a common electrode, and the bottom substrate includes a pixel electrode. The liquid crystal layer is disposed between the top substrate and bottom substrate, and has pluralities of liquid crystal molecules. When no voltage is applied between the common electrode and the pixel electrode, the liquid crystal molecules of the OCB-LCD are normally in a state of splay alignment. In order to change the refraction via bend alignment so as to display a frame, all of the liquid crystal molecules of the display region must be uniformly converted to a state of bend alignment from a state of splay alignment before the frame is displayed by the OCB-LCD. If only an AC current is applied between the pixel electrode and the common electrode, the liquid crystal molecules will not rotate uniformly, or even have to spend a long duration of time to be converted from a state of splay alignment to a state of bend alignment. During the shifting process, quite often the liquid crystal molecules can not be uniformly converted into a state of bend alignment from a state of splay alignment, resulting in a non-uniform arrangement of liquid crystal molecules. As a result, the luminance of the LCD panel is non-uniform, the display quality is poor and the yielding rate of the LCD is largely reduced.

When a conventional OCB-LCD panel is converted to a state of bend alignment from a state of splay alignment, the conventional OCB-LCD panel merely provides an AC current between the common electrode and the pixel electrode. Quite often, the alignment state can not be converted successfully and defects are resulted. Worse than that, the initialization of bend alignment takes a long time, severely jeopardizing the practicality of OCB-LCD.

### SUMMARY OF THE INVENTION

The invention is directed to a liquid crystal display (LCD) panel and a driving method thereof. The pixel electrode partly overlaps the signal line for forming a fringe vertical field having different directions between the pixel electrode and the signal line to disturb the arrangement of the liquid crystal molecules in the liquid crystal layer and produce a transition nucleus area accordingly. Thus, the liquid crystal molecules are uniformly and evenly converted into a state of bend alignment from a state of splay alignment via transition nucleus area.

According to a first aspect of the present invention, an LCD panel including a first substrate, a second substrate and a liquid crystal layer is provided. The first substrate includes a signal line, an insulating layer and a pixel electrode. The insulating layer is disposed between the signal line and the pixel electrode. The pixel electrode partly overlaps the signal line. The second substrate is parallel to the first substrate. The liquid crystal layer is disposed between the first substrate and the second substrate. When a cross-voltage between the signal line and the pixel electrode is applied, a fringe vertical field having different directions is formed on the peripheral of the partly overlapped area between the signal line and the pixel electrode, such that the liquid crystal layer produces at least one transition nucleus area according to the fringe vertical field.

According to a second aspect of the present invention, a driving method of an LCD panel is provided. First, an LCD panel including a first substrate, a second substrate and a liquid crystal layer is provided. The first substrate includes a signal line, an insulating layer and a pixel electrode. The insulating layer is disposed between the signal line and the pixel electrode. The pixel electrode partly overlaps the signal line. The second substrate is parallel to the first substrate. The liquid crystal layer is disposed between the first substrate and the second substrate. Next, a cross-voltage is applied between the signal line and the pixel electrode for forming a fringe vertical field having different directions on the peripheral of the partly overlapped area between the signal line and the pixel electrode, such that the liquid crystal layer produces at least one transition nucleus area according to the fringe vertical field.

The invention will become apparent from the following detailed description of the preferred but non-limiting embodiments. The following description is made with reference to the accompanying drawings.

### BRIEF DESCRIPTION OF THE DRAWINGS

FIG. 1A is a top view of a first substrate of an LCD panel according to a first embodiment of the invention;

FIG. 1B is a cross-sectional view of a first substrate, a liquid crystal layer and a second substrate of an LCD panel viewed along a cross-sectional line 1B-1B′ of FIG. 1A;

FIG. 1C is a cross-sectional view showing a fringe vertical field disturbing a liquid crystal layer according to a first embodiment of the invention;

FIG. 2 is a driving method of LCD panel according to a first embodiment of the invention;

FIG. 3 is a top view of a first substrate of an LCD panel according to a second embodiment of the invention;

FIG. 4 is a top view of a first substrate of an LCD panel according to a third embodiment of the invention;

FIG. 5 is a top view of a first substrate of an LCD panel according to a fourth embodiment of the invention; and

FIG. 6 is a top view of a first substrate of an LCD panel according to a fifth embodiment of the invention.

### DETAILED DESCRIPTION OF THE INVENTION

### First Embodiment

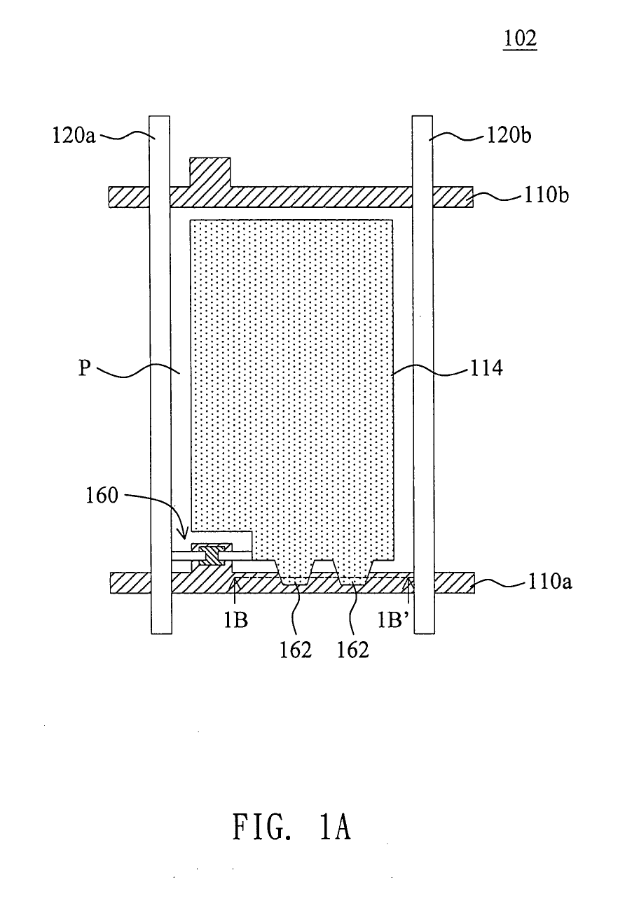

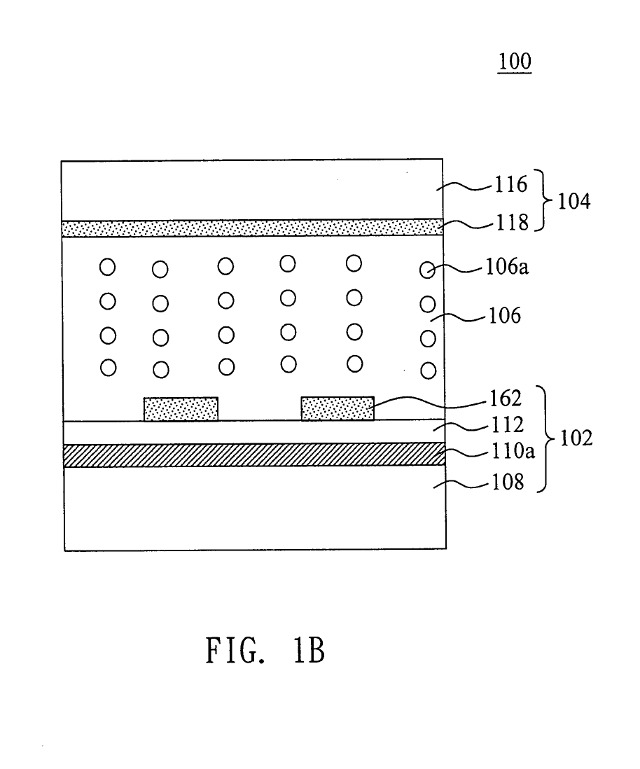

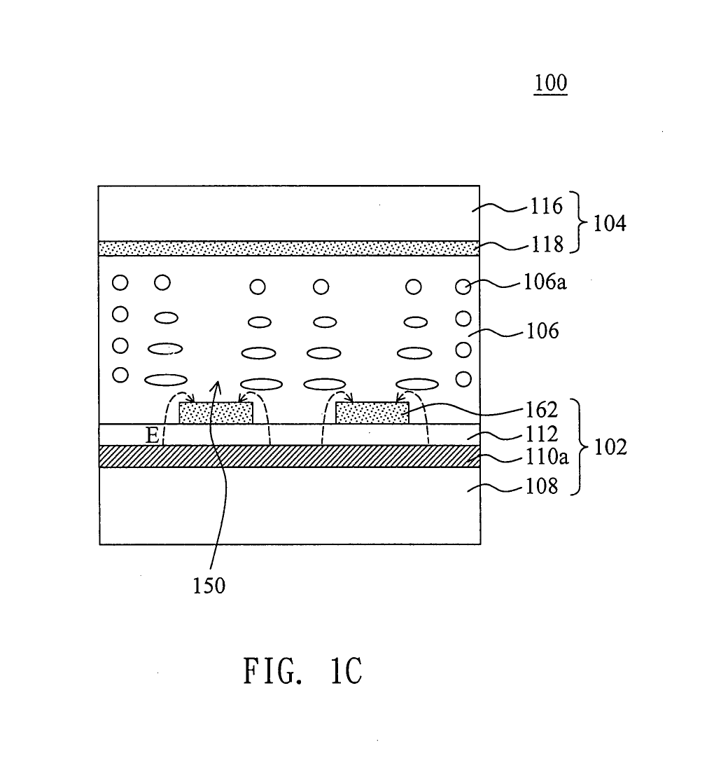

Referring to FIGS. 1A˜1B. FIG. 1A is a top view of a first substrate of an LCD panel according to a first embodiment of the invention. FIG. 1B is a cross-sectional view of a first substrate, a liquid crystal layer and a second substrate of an LCD panel viewed along a cross-sectional line 1B˜1B′ of FIG. 1A. As indicated in FIGS. 1A˜1B, the LCD panel 100 includes a first substrate 102, a second substrate 104 and a liquid crystal layer 106. The first substrate 102 includes a first base 108, a signal line 110a, an insulating layer 112 and a pixel electrode 114. The second substrate 104 includes a second base 116 and a common electrode 118. The signal line 110a is disposed on the first base 108. The insulating layer 112 is disposed on the first base 108 and covers up the signal line 110a. The pixel electrode 114 is disposed on the insulating layer 112 and partly overlaps the signal line 110a. In the present embodiment of the invention, the pixel electrode 114 has at least one first protruding portion 162, such as two first protruding portions 162, and the pixel electrode 114 partly overlaps and the signal line 110a by the first protruding portion 162. The common electrode 118 is disposed on the second base 116. The liquid crystal layer 106 is disposed between the first substrate 102 and the second substrate 104, and has pluralities of liquid crystal molecules 106a. The LCD panel 100 is used in an optical compensated bend (OCB) LCD, and the liquid crystal molecules 106a of FIG. 1B are in a state of splay alignment.

Referring to FIG. 1C, a cross-sectional view showing a fringe vertical field disturbing a liquid crystal layer according to a first embodiment of the invention is shown. As indicated in FIG. 1C, when a first cross-voltage is applied to the signal line 110a and the first protruding portion 162 (a partial structure of the pixel electrode 114 of FIG. 1A), that is, when a first cross-voltage is applied to the signal line 110a and the pixel electrode 114 of FIG. 1A, a fringe vertical field E having different directions is formed on the peripheral of the partly overlapped area between the signal line 110a and the first protruding portion 162 (a partial structure of the pixel electrode 114 of FIG. 1A) to disturb the arrangement of the liquid crystal molecules 106a and cause the liquid crystal layer 106 to produce at least one transition nucleus area 150 according to the fringe vertical field. In the present embodiment of the invention, three transition nucleus areas 150 are produced. As a result, the energy barrier arising when the liquid crystal molecules 106a are converted into a state of bend alignment from a state of splay alignment is reduced.

When a second cross-voltage is applied to the pixel electrode 114 and the common electrode 118, the liquid crystal molecules 106a are promptly converted into a state of bend alignment from a state of splay alignment according to the transition nucleus area 150 and are quickly initiated. The first cross-voltage is different from the second cross-voltage, and the fringe vertical field E is substantially perpendicular to the surface of the first base 108.

In the present embodiment of the invention, if the voltages applied to the pixel electrode 114 and the signal line 110a are 0V and 15V respectively, then the first cross-voltage between the pixel electrode 114 and the signal line 110a is 15V. If the voltages applied to the pixel electrode 114 and the common electrode 118 are 0 and 5V respectively, then the second cross-voltage between the pixel electrode 114 and the common electrode 118 is 5V.

As indicated in FIG. 1A, the signal line 110a is the first scan line, and the first substrate 102 further includes a second scan line 110b, a first data line 120a, a second data line 120b and a thin film transistor 160. The second scan line 110b and the first scan line (that is, the signal line 110a) are disposed on the first base 108 in parallel. The first data line 120a and the second data line 120b are disposed on the first base 108 in parallel and are covered up by the insulating layer 112. The first scan line (that is, the signal line 110a) and the second scan line 110b are criss-crossed with the first data line 120a and the second data line 120b so as to define a pixel P. A pixel electrode 114 is disposed in the pixel P. The thin film transistor 160 is disposed in the pixel P and is electrically connected with the first scan line (that is, the signal line 110a), the first data line 120a and the pixel electrode 114 respectively. The pixel electrode 114 has at least one first protruding portion 162 such as two first protruding portions 162, and partly overlaps the signal line 110a. The first protruding portion 162 is wedge-shaped. However, any one who is skilled in the technology of the invention will understand that the shape of the first protruding portion can be circular, triangular or rectangular, and the shape and the type of the first protruding portion do not limit the scope of protection of the invention. In the present embodiment of the invention, the first protruding portion 162 of the pixel electrode 114 is electrically connected with the source/drain of the thin film transistor 160 and partly overlaps the signal line 110a (that is, the first scan line) electrically connected with the gate of the thin film transistor 160.

In the present embodiment of the invention, the pixel electrode 114 partly overlaps the signal line 110a, and when a first cross-voltage is applied to the peripheral of the partly overlapped area between the pixel electrode 114 and the signal line 110a, a fringe vertical field E having different directions is formed to disturb the arrangement of the liquid crystal molecules 106a in the liquid crystal layer 106 and produce at least one transition nucleus area according to the fringe vertical field 150. As a result, the energy barrier arising when the liquid crystal molecules 106a are converted into a state of bend alignment from a state of splay alignment is reduced. When a second cross-voltage is applied to the common electrode 118 and the pixel electrode 114, the disturbed liquid crystal molecules 106a are identically and evenly converted into a state of bend alignment from a state of splay alignment according to the transition nucleus area 150 and are quickly and uniformly initiated. The liquid crystal layer 106 being uniformly arranged not only makes the luminance of the LCD panel 100 uniformly distributed and enhances the display quality but also indirectly increases the yielding rate of the LCD panel 100. Furthermore, the present embodiment of the invention meets the user's requirements of the LCD panel 100 by providing wider view angle and faster response rate, hence largely improving the practicality of the LCD panel 100.

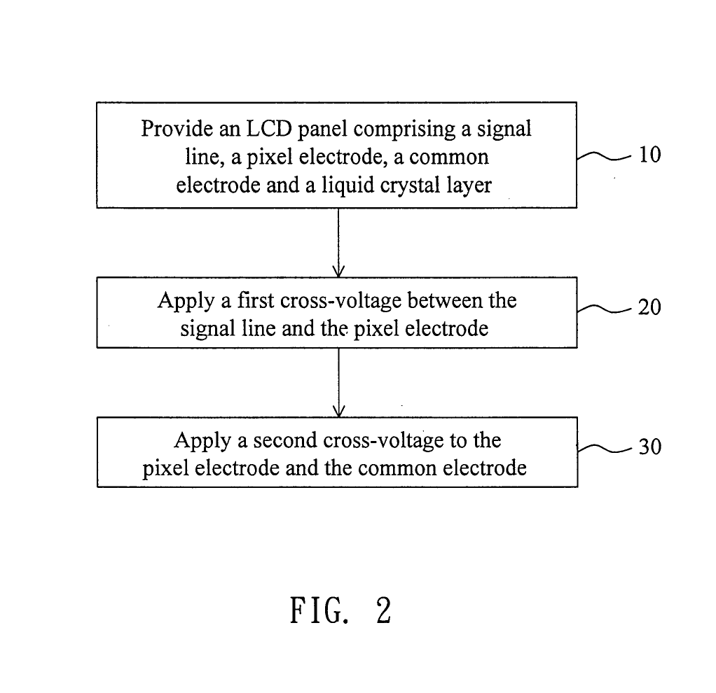

The flowchart of driving the LCD panel of the present embodiment of the invention 100 is stated below. Referring to FIGS. 1A-1C and FIG. 2. FIG. 2 is a driving method of LCD panel according to a first embodiment of the invention. First, the method begins at step 10. As indicated in FIGS. 1A˜1B, an LCD panel 100 including a first substrate 102, a second substrate 104 and a liquid crystal layer 106 is provided. The first substrate 102 includes a first base 108, a signal line 110a, an insulating layer 112 and a pixel electrode 114. The signal line 110a is disposed on the first base 108. The insulating layer 112 is disposed on the first base 108 and covers up the signal line 110a. The pixel electrode 114 is disposed on the insulating layer 112 and partly overlaps the signal line 110a by the first protruding portion 162. The second substrate 104 includes a second base 116 and a common electrode 118. The common electrode 118 is disposed on the second base 116. The liquid crystal layer 106 is disposed between the first substrate 102 and the second substrate 104, and has pluralities of liquid crystal molecules 106a.

Next, the method proceeds to step 20. As indicated in FIG. 1C, a first cross-voltage between the signal line 110a and the first protruding portion 162 is applied (a partial structure of the pixel electrode 114 of FIG. 1A) for forming a fringe vertical field E having different directions on the peripheral of the partly overlapped area between the signal line 110a and the first protruding portion 162 (a partial structure of the pixel electrode 114 of FIG. 1A), such that the liquid crystal layer 106 produces at least one transition nucleus area such as three transition nucleus areas 150 according to the fringe vertical field 150. In step 20, a voltage such as 15V is provided to all of the scan lines including the signal line 110a and the second scan line 110b by way of synchronical scanning. Meanwhile, the pixel electrode does not receive any voltage (such as 0V). Thus, a first cross-voltage such as 15V is generated between the signal line 110a and the first protruding portion 162.

Then, the method proceeds to step 30, a second cross-voltage between the pixel electrode 114 and the common electrode 118 is applied, such that the liquid crystal layer 106 are promptly converted into a state of bend alignment from a state of splay alignment according to the transition nucleus area 150, wherein the first cross-voltage is different from the second cross-voltage. In step 30, a pixel voltage such as 5V is provided to the pixel electrode 114 via data line 120a and the turned-on thin film transistor 160, therefore a second cross-voltage such as 5V is generated between the common electrode 118 which has a fixed voltage such as 0V and the pixel electrode 114.

### Second Embodiment

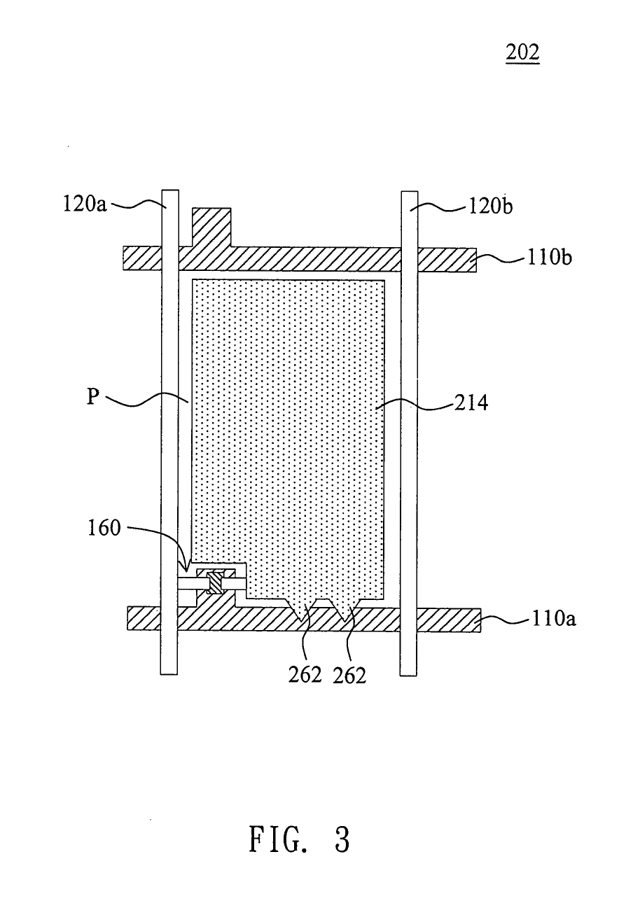

Referring to FIG. 3, a top view of a first substrate of an LCD panel according to a second embodiment of the invention is shown. The LCD panel of the present embodiment of the invention differs with the LCD panel 100 of the first embodiment in the first substrate 202. The first substrate 202 of the present embodiment of the invention differs with the first substrate 102 of the first embodiment in the shape and the design of the first protruding portion 262 of the pixel electrode 214. As for other similarities, the same numeric designations are used and are not repeated here. As indicated in FIG. 3, the first protruding portion 262 of the pixel electrode 214 is triangular, and the first protruding portion 262 partly overlaps the signal line 110a. When a first cross-voltage is applied to the pixel electrode 214 and the signal line 110a, a fringe vertical field having different directions is formed on the peripheral of the partly overlapped area between the pixel electrode 214 and the signal line 110a to disturb the arrangement of the liquid crystal molecules in the liquid crystal layer of the LCD panel and produce at least one transition nucleus area according to the fringe vertical field. As a result, the energy barrier arising when the liquid crystal molecules of the LCD panel are converted into a state of bend alignment from a state of splay alignment is reduced. When a second cross-voltage is applied to the common electrode and the pixel electrode 214, the disturbed liquid crystal molecules 106a are uniformly and evenly converted into a state of bend alignment from a state of splay alignment according to the transition nucleus area and are quickly initiated. Any one who is skilled in the technology of the invention will understand that the driving method of the LCD panel of the first embodiment is also applicable to the LCD panel of the present embodiment of the invention, and the shape and the design of the first protruding portion of the pixel electrode do not affect the process of driving the LCD panel.

### Third Embodiment

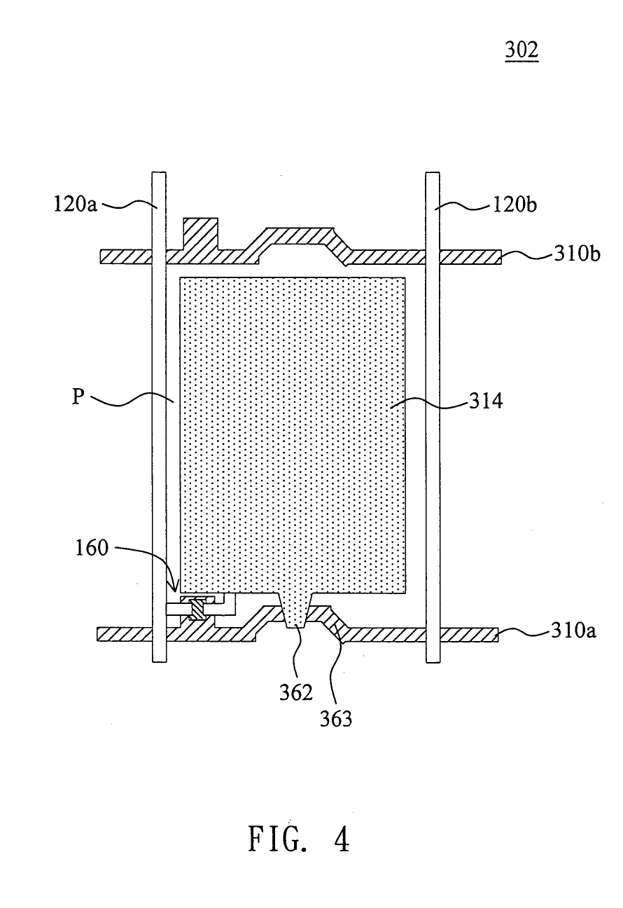

Referring to FIG. 4, a top view of a first substrate of an LCD panel according to a third embodiment of the invention is shown. The LCD panel of the present embodiment of the invention differs with the LCD panel 100 of the first embodiment in the first substrate 302. The first substrate 302 of the present embodiment of the invention differs with the first substrate 102 of the first embodiment in the number of the first protruding portion 362 of the pixel electrode 314 as well as the shape and the design of the signal line 310a. As for other similarities, the same numeric designations are used and are not repeated here. As indicated in FIG. 4, the first protruding portion 362 of the pixel electrode 314 is wedge-shaped, and is exemplified by one first protruding portion 362 only. The signal line 310a has a bending portion 363 partly overlapping the first protruding portion 362. When a first cross-voltage is applied to the pixel electrode 314 and the signal line 310a, a fringe vertical field having different directions is formed on the peripheral of the partly overlapped area between the pixel electrode 314 and the signal line 310a to disturb the arrangement of the liquid crystal molecules in the liquid crystal layer of the LCD panel and produce at least one transition nucleus area according to the fringe vertical field. As a result, the energy barrier arising when the liquid crystal molecules of the LCD panel are converted into a state of bend alignment from a state of splay alignment is reduced. When a second cross-voltage is applied to the common electrode and the pixel electrode 314, the disturbed liquid crystal molecules 106a are identically and evenly converted into a state of bend alignment from a state of splay alignment according to the transition nucleus area and are quickly and uniformly initiated. Any one who is skilled in the technology of the invention will understand that the driving method of the LCD panel of the first embodiment is also applicable to the LCD panel of the present embodiment of the invention, and the shape and the design of the first protruding portion of the pixel electrode do not affect the process of driving the LCD panel.

### Fourth Embodiment

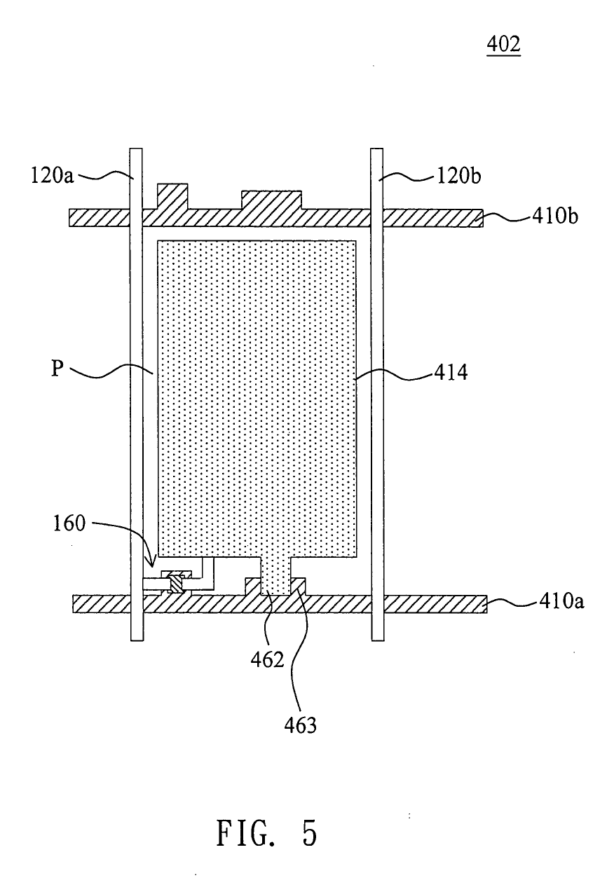

Referring to FIG. 5, a top view of a first substrate of an LCD panel according to a fourth embodiment of the invention is shown. The LCD panel of the present embodiment of the invention differs with the LCD panel 100 of the first embodiment in the first substrate 402. The first substrate 402 of the present embodiment of the invention differs with the first substrate 102 of the first embodiment in the number, the shape and the design of the first protruding portion 462 of the pixel electrode 414 as well as the shape and the design of the signal line 410a. As for other similarities, the same numeric designations are used and are not repeated here. As indicated in FIG. 5, the first protruding portion 462 of the pixel electrode 414 is rectangular, and the signal line 410a has a second protruding portion 463 partly overlapping the first protruding portion 462. When a first cross-voltage is applied to the pixel electrode 414 and the signal line 410a, a fringe vertical field having different directions is formed on the peripheral of the partly overlapped area between the pixel electrode 414 and the signal line 410a to disturb the arrangement of the liquid crystal molecules in the liquid crystal layer of the LCD panel and produce at least one transition nucleus area according to the fringe vertical field. As a result, the energy barrier arising when the liquid crystal molecules of the LCD panel are converted into a state of bend alignment from a state of splay alignment is reduced. When a second cross-voltage is applied to the common electrode and the pixel electrode 414, the disturbed liquid crystal molecules 106a are identically and evenly converted into a state of bend alignment from a state of splay alignment according to the transition nucleus area and are quickly and uniformly initiated. Any one who is skilled in the technology of the invention will understand that the driving method of the LCD panel of the first embodiment is also applicable to the LCD panel of the present embodiment of the invention, and the shape and the design of the first protruding portion of the pixel electrode as well as the shape and the design of the second protruding portion of the signal line do not affect the process of driving the LCD panel.

### Fifth Embodiment

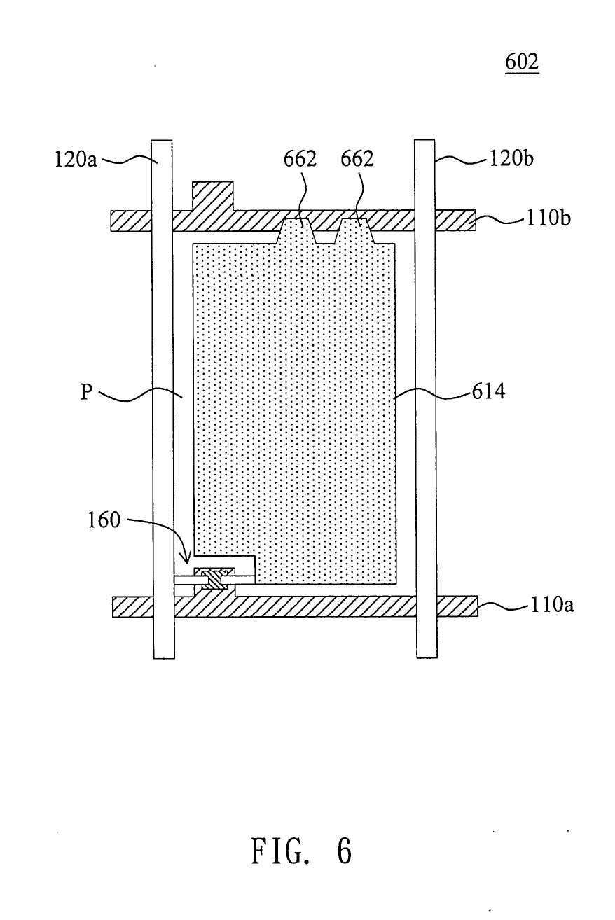

Referring to FIG. 6, a top view of a first substrate of an LCD panel according to a fifth embodiment of the invention is shown. The LCD panel of the present embodiment of the invention differs with the LCD panel 100 of the first embodiment in the first substrate 602. The first substrate 602 of the present embodiment of the invention differs with the first substrate 102 of the first embodiment in the pixel electrode 614 and the protrusion of the first protruding portion 662. As for other similarities, the same numeric designations are used and are not repeated here. As indicated in FIG. 6, the pixel electrode 614 has at least one first protruding portion 662 partly overlapping another signal line (that is, the second scan line 110b). In the present embodiment of the invention, the first protruding portion 662 of the pixel electrode 614 is electrically connected with the source/drain of the thin film transistor 160. The first protruding portion 662 of the pixel electrode 614 partly overlaps the second scan line 110b electrically connected with the gate of the thin film transistor of the previous pixel instead of partly overlapping the signal line 110a electrically connected with the gate of the thin film transistor 160 of the pixel P.

When a first cross-voltage is applied to the pixel electrode 614 and the second scan line 110b, a fringe vertical field having different directions is formed on the peripheral of the partly overlapped area between the pixel electrode 614 and the signal line 110b to disturb the arrangement of the liquid crystal molecules in the liquid crystal layer of the LCD panel and produce at least one transition nucleus area according to the fringe vertical field. As a result, the energy barrier arising when the liquid crystal molecules of the LCD panel are converted into a state of bend alignment from a state of splay alignment is reduced. When a second cross-voltage is applied to the common electrode and the pixel electrode 614 of the second substrate, the disturbed liquid crystal molecules are identically and evenly converted into a state of bend alignment from a state of splay alignment according to the transition nucleus area and are quickly and uniformly initiated.

Any one who is skilled in the technology of the invention will understand that the driving method of the LCD panel of the first embodiment is also applicable to the LCD panel of the present embodiment of the invention, and the shape and the design of the first protruding portion 662 of the pixel electrode 614 do not affect the process of driving the LCD panel. For example, the first protruding portion 662 can be wedge-shaped, triangular, rectangular, or irregular.

When a first cross-voltage is applied to the pixel electrode 614 and the second scan line 110b, apart from simultaneously providing a voltage to all scan lines including the signal line 110a and the second scan line 110b by way of synchronical scanning, the voltage can be sequentially provided to the second scan line 110b and the signal line 110a by way of line-by-line scanning. Afterwards, a second cross-voltage is applied to the pixel electrode 614 and the common electrode, such that the liquid crystal layer are converted into a state of bend alignment from a state of splay alignment according to transition nucleus area, wherein the first cross-voltage is different from the second cross-voltage.

According to the LCD panel and the driving method thereof disclosed in the above embodiments of the invention, the pixel electrode overlaps the signal line, such that a fringe vertical field having different directions is formed on the peripheral of the partly overlapped area between the pixel electrode and the signal line to disturb the arrangement of the liquid crystal molecules in the liquid crystal layer and produce at least one transition nucleus area according to the fringe vertical field. The disturbed liquid crystal molecules are converted into a state of bend alignment from a state of splay alignment according to the transition nucleus. The liquid crystal molecules being uniformly arranged not only make the luminance of the LCD panel uniformly distributed and enhance the display quality but also indirectly increase the yielding rate of the LCD panel.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) panel, comprising:
a first substrate, comprising:
a signal line and a pixel electrode, wherein the signal line and the pixel electrode partly overlap with each other; and
an insulating layer disposed between the signal line and the pixel electrode;
a second substrate disposed in parallel with the first substrate; and
a liquid crystal layer disposed between the first substrate and the second substrate;
wherein, when a first cross-voltage between the signal line and the pixel electrode is applied, a fringe vertical field having different directions is formed on the peripheral of the partly overlapped area between the signal line and the pixel electrode, such that the liquid crystal layer produces at least one transition nucleus area according to the fringe vertical field.

2. The LCD panel according to claim 1, wherein the second substrate further comprises a common electrode, the liquid crystal layer has a plurality of liquid crystal molecules, and when a second cross-voltage between the pixel electrode and the common electrode is applied, the liquid crystal molecules are promptly converted to a state of bend alignment from a state of splay alignment according to the transition nucleus area.

3. The LCD panel according to claim 2, wherein the first cross-voltage is different from the second cross-voltage.

4. The LCD panel according to claim 1, wherein the signal line is a first scan line, and the first substrate further comprises:
a second scan line disposed in parallel with the first scan line; and
a first data line disposed in parallel with a second data line, wherein the first scan line and the second scan line are crisscrossed with the first data line and the second data line to define a pixel, and the pixel electrode is disposed in the pixel.

5. The LCD panel according to claim 4, wherein the first substrate further comprises:
a thin film transistor disposed in the pixel and respectively electrically connected with the first scan line, the first data line and the pixel electrode.

6. The LCD panel according to claim 4, wherein the first substrate further comprises:
a thin film transistor disposed in the pixel and respectively electrically connected with the second scan line, the first data line and the pixel electrode.

7. The LCD panel according to claim 1, wherein the pixel electrode has at least one first protruding portion partly overlapping the signal line.

8. The LCD panel according to claim 7, wherein the first protruding portion is wedge-shaped, triangular or rectangular.

9. The LCD panel according to claim 7, wherein the signal line has at least one bending portion partly overlapping the first protruding portion.

10. The LCD panel according to claim 7, wherein the signal line has at least one second protruding portion partly overlapping the first protruding portion.

11. The LCD panel according to claim 1, being used in an optically compensated bend (OCB) LCD.

12. A driving method of an LCD panel, the method comprising:
providing an LCD panel comprising a first substrate, a second substrate and a liquid crystal layer, wherein the first substrate comprises a signal line, an insulating layer and a pixel electrode, the insulating layer is disposed between the signal line and the pixel electrode, the pixel electrode partly overlaps the signal line, the liquid crystal layer is disposed between the first substrate and the second substrate; and
applying a first cross-voltage between the signal line and the pixel electrode for forming a fringe vertical field having different directions on the peripheral of the partly overlapped area between the signal line and the pixel electrode, such that the liquid crystal layer produces at least one transition nucleus area according to the fringe vertical field.

13. The method according to claim 12, wherein the second substrate further comprises a common electrode, the liquid crystal layer has a plurality of liquid crystal molecules, the method further comprises:
applying a second cross-voltage between the pixel electrode and the common electrode, such that the liquid crystal molecules are promptly converted into a state of bend alignment from a state of splay alignment according to the transition nucleus area.

14. The method according to claim 13, wherein the first cross-voltage is different from the second cross-voltage.

15. The method according to claim 12, wherein the signal line is a first scan line, and the first substrate further comprises:
a second scan line disposed in parallel with the first scan line; and
a first data line and a second data line, wherein the first scan line and the second scan line are disposed in parallel with each other and are criss-crossed with the first data line and the second data line to define a pixel, and the pixel electrode is disposed in the pixel.

16. The method according to claim 15, wherein the first substrate further comprises:
a thin film transistor disposed in the pixel and respectively electrically connected with the first scan line, the first data line and the pixel electrode.

17. The method according to claim 16, wherein the step of applying the first cross-voltage between the signal line and the pixel electrode further comprises:
simultaneously providing a voltage between the first scan line and the second scan line by way of synchronical scanning.

18. The method according to claim 15, wherein the first substrate further comprises:
a thin film transistor disposed in the pixel and respectively electrically connected with the second scan line, the first data line and the pixel electrode.

19. The method according to claim 18, wherein the step of applying the first cross-voltage to the signal line and the pixel electrode further comprises:
sequentially providing a voltage to the first scan line and the second scan line by way of line-by-line scanning.

20. The method according to claim 18, wherein the step of applying the first cross-voltage to the signal line and the pixel electrode further comprises:
simultaneously providing a voltage to the first scan line and the second scan line by way of synchronical scanning.

21. The method according to claim 12, wherein the pixel electrode has at least one first protruding portion partly overlapping the signal line.

22. The method according to claim 21, wherein the first protruding portion is wedge-shaped, triangular, or rectangular.

23. The method according to claim 21, wherein the signal line has at least one bending portion overlapping the first protruding portion.

24. The method according to claim 21, wherein the signal line has at least one second protruding portion partly overlapping the first protruding portion.

25. The method according to claim 12, wherein the LCD panel is used in an OCB-LCD panel.
